(19) United States
(12) Patent Application Publication
(10) Pub. No.: US 2005/0249522 A1
(43) Pub. Date: Nov. 10, 2005

(54) Process cartridge for image forming apparatus

(75) Inventor: Jong-Hyun Park, Gycyang-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/023,111

(22) Filed: Dec. 28, 2004

(30) Foreign Application Priority Data
May 4, 2004 (KR) 2004-31262

(51) Int. Cl. G03G 15/08

(52) U.S. Cl. 399/120

(57) ABSTRACT

A process cartridge for an image forming apparatus has a developer cartridge having a toner inlet and a waste toner outlet. A toner cartridge is detachably mountable to the developer cartridge. An opening and closing unit substantially simultaneously opens and closes a toner supply route and a waste toner collection route through a lever operation. The opening and closing unit includes a rotary lever installed on the toner cartridge. One end of the rotary level protrudes outside of the toner cartridge and rotates in the forward and backward direction. A rotary opening and closing unit rotates along with the rotary lever to open and close the toner supply route. A slide opening and closing unit slides along in response to the rotation of the rotary lever to open and close the waste toner collection route.

### CROSS-REFERENCE TO RELATED APPLICATIONS

This application claims the benefit under 35 U.S.C. § 119(a) of Korean Patent Application No. 2004-31262, filed on May 4, 2004 with the Korean Intellectual Property Office, the entire content of which is hereby incorporated by reference.

### BACKGROUND OF THE INVENTION

1. Field of the Invention

The present invention relates to a process cartridge for an image forming apparatus. Examples of the image forming apparatus include electrophotographic copying machines, electrophotographic printers, fax machines, word processors or the like. A process cartridge refers to a combined developer-toner cartridge assembly that is detachably mounted on a main assembly of the image forming apparatus in which the process cartridge assembly internally contains a photosensitive medium, a charging unit, a developing unit, and a cleaning unit.

2. Description of the Related Art

Typically, an image forming apparatus incorporating an electrophotographic process uses a process cartridge. The process cartridge is well-known for its easy operability, maneuverability and maintenance, even for an unskilled user without the necessity of relying on a serviceman. Therefore, the process cartridge type machines are broadly used in the field of image forming apparatuses.

The process cartridge includes a developer cartridge, and a toner cartridge detachably mounted on the developer cartridge to provide toner to the developer cartridge.

More specifically, the developer cartridge includes a photosensitive medium, a developing unit for adhering toner provided from the toner cartridge to the photosensitive medium to develop an electrostatic latent image formed on the photosensitive medium, a cleaning unit for emptying toner left over on the photosensitive drum, and a cartridge frame for accommodating and supporting these members, including a channel with a toner inlet and waste toner outlet formed on the top and bottom thereof.

The toner cartridge includes a cartridge frame whose interior is partitioned by a partitioning wall into a toner container and a waste toner container, and a cover for covering the frame. The toner container in the cartridge frame has toner supply ports forming a toner supply route connected to the toner inlet of the developing cartridge. The waste toner container of the cover has a waste toner inlet forming a waste toner collection route connected to the waste toner outlet of the developer cartridge.

The above-described process cartridge is usually mounted on a cartridge installing portion housed in a main body of the image forming apparatus. At first, the developer cartridge is mounted on the cartridge installing portion and the toner cartridge is slid on the developer cartridge. The toner cartridge supplies toner stored inside to the developer cartridge via the toner supply route. This is possible because the toner cartridge is combined with the developer cartridge and thus, communicates with the toner supply route. The toner being supplied is adhered to an electrostatic latent image formed on the photosensitive medium by the developing unit, and a resulting visible image is transferred onto a printing medium that passes through the photosensitive medium for printing the visible image.

Meanwhile, a small amount of the toner on the photosensitive medium is not transferred onto the printing medium but left behind. This residual waste toner is removed by the cleaning unit equipped in the developer cartridge, and is dumped to the waste toner container of the toner cartridge via the designated waste toner collection route.

If the developer cartridge and the toner cartridge are separated by an opening and closing member, the toner supply route and the waste toner collection route are closed. However, if the developer cartridge and the toner cartridge are combined and installed in the main body of the image forming apparatus as one unit, the toner supply route and the waste toner collection route should be opened. If the toner supply route and the waste toner collection route are not closed when the developer cartridge and the toner cartridge are separated, the waste toner can leak through the waste toner outlet of the developer cartridge. As a result, the image forming apparatus could become contaminated. Also, the toner can leak through the toner supply port of the toner cartridge.

Korean Patent Laid-Open No. 1999-29393 (opened to the public on Apr. 26, 1999) discloses a combination structure of developer and waste toner collecting device, in which an outlet shutter covering an outlet formed on a developer and a collecting port shutter covering a collecting port formed on a waste toner collecting device are combined with the developer and the waste toner collecting device, respectively. Thus, when the collecting port shutter is rotated, the outlet shutter is also rotated following the collecting port shutter. In this manner, the outlet and the collecting port were communicate with each other.

However, because the collecting port shutter and the outlet shutter in the combination structure of developer and waste toner collecting device are installed in such a manner that they follow each other, it is very important to make sure that the developer and the waste toner collecting device are properly combined. If not, it is possible that only the outlet is opened while the collecting outlet is shut. If a printing operation proceeds in this state, waste toner cannot be discharged, the printing quality can be deteriorated, and the interior of the image forming apparatus can be contaminated by the waste toner.

Korean Patent Laid-Open No. 2002-58323 (opened to the public on Jul. 12, 2002) discloses a developer-toner cartridge assembly in which an opening and closing member for selectively opening and closing a toner inlet formed on an exterior case of a developer, a first opening and closing means for selectively opening and closing a toner supply port formed on an exterior case of a toner cartridge, and a second opening and closing means for constraining the opening and closing member at the time of detaching the toner cartridge from the developer work together to interconnect the developer with the toner cartridge. The interconnected developer and toner cartridge eases opening and closing a toner supply route and a waste toner collection route.

Despite the above advantages, problems exist with the developer-toner cartridge assembly, such as a complicated design requiring many hooks and jaws, difficult manufacturing challenges, and high manufacture costs. In addition, since the opening or closing operation of the toner supply route and the waste toner collection route is connected to the detachment of the toner cartridge, it is very important to have high precision for a joint part. For example, if the precision requirement is not met, the opening or closing operation of the toner supply route and/or the waste toner collection route cannot be performed in a timely and precise manner resulting in the leakage of toner.

If the toner is not properly supplied from the toner supply unit due to toner leakage, image density is deteriorated and the image forming apparatus is contaminated. Also, if the waste toner is not collected timely, the waste toner collecting unit can become overloaded and damaged. Furthermore, a cleaning blade in contact with the photosensitive medium may not function properly, which causes the leakage of waste toner, thereby resulting in deterioration of image quality.

### SUMMARY OF THE INVENTION

It is, therefore, an aspect of the present invention to provide an easy-to-use process cartridge for an image forming apparatus in which a toner supply route and a waste toner collection route are substantially simultaneously opened or closed by a simple operation of a lever.

Another aspect of the present invention is to provide a process cartridge for an image forming apparatus having a simple structure, high reliability in operation, reduced toner leakage, and a low manufacture cost.

To achieve the above aspects and advantages, there is provided a process cartridge for an image forming apparatus having a developer cartridge and a toner cartridge detachably mountable on the developer cartridge. An opening and closing unit substantially simultaneously opens and closes a toner supply route and a waste toner collection route through a one-time lever operation.

The developer cartridge has a photosensitive medium and a frame to rotatably support the photosensitive medium in which the frame has a channel formed at proper positions of the upper and lower portions of the toner inlet and the waste toner outlet, respectively.

The developer cartridge, which is combined with the toner cartridge, is connected through the channel, uses toner supplied from the toner cartridge and develops an electrostatic latent image on the photosensitive medium.

The developer cartridge includes a charging unit for charging the photosensitive medium, a carrier mixing-agitating element for mixing and agitating toner supplied from the toner cartridge, and a carrier to convey the toner. A magnetic developing roller transfers the magnetic toner-carrier mixture from the carrier mixing-agitating element onto the photosensitive medium. A cleaning unit removes any residual waste toner on the photosensitive medium.

The toner cartridge has a frame whose interior is partitioned into a toner container and a waste toner container, and a cover combined with the frame. A toner supply port is formed on one side of the toner container of the frame to allow communication with the toner inlet of the developer cartridge at a time of the combination of the toner cartridge with the developer cartridge. A waste toner inlet is formed on one side of the cover corresponding to the waste toner container of the frame to allow communication with the waste toner outlet of the developer cartridge at a time of the combination of the toner cartridge with the developer cartridge.

The toner cartridge may further include an agitator to agitate the toner stored in a toner container and to transfer the toner towards the toner supply port.

The opening and closing unit for the toner supply route and the waste toner collection route includes a rotary lever installed on the toner cartridge in a manner that one end thereof protrudes outside thereof and rotates in the forward and backward direction. Arotary opening and closing unit rotating along with the rotary lever opens and closes the toner supply route. A slide opening and closing unit slides along the rotation of the rotary lever to open and close the waste toner collection route.

The rotary opening and closing unit includes an opening that allows communication between the toner supply port and the toner inlet. A circular arc shaped shutter is adapated to shut the toner supply port and the toner inlet. A rotary opening and closing member is connected to the other end of the rotary lever, which is rotated to a toner supply route's opened position where the opening corresponds to the toner inlet and to a toner supply route's closed position where the shutter corresponds to the toner inlet.

The slide opening and closing unit includes a waste toner collection route connecting member connected to the waste toner outlet of the developer cartridge and having a through hole in a vertical direction and a conical shaped end. A first slide opening and closing member has an opening that allows communication between the through hole of the waste toner collection route connecting member and the waste toner inlet A shutter is adapted to shut the through hole and the waste toner inlet, and slides between a waste toner collection route's opened position where the through hole corresponds to the opening at a lower portion of the waste toner outlet and a waste toner collection route's closed position where the through hole corresponds to the shutter. A second slide opening and closing member is movably installed on one side of the waste toner inlet of the toner cartridge and is connected to the rotary lever by a link member to slide along the rotation of the rotary lever. The second slide opening and closing member is connected to the first slide opening and closing member at a time of the connection of the toner cartridge with the developer cartridge to move the first slide opening and closing member to the opened and closed positions.

A toner supply roller is rotatably installed inside the rotary opening and closing member to facilitate toner supply operation.

A pair of guide members and a pair of hooking members are installed on a lower surface of the first slide opening and closing member for use in combination with the second slide opening and closing member. A pair of jaws in a one-to-one correspondence to the hooking members are installed on an upper surface of the second slide opening and closing member; and a connecting hole is formed between the jaws of the second slide opening and closing member to correspond to the opening of the first slide opening and closing member.

A conical shaped end of the waste toner collection route connecting member in an opened position is fitted into the opening of the first slide opening and closing member. A conical shaped end in a closed position is in contact with the shutter of the first slide opening and closing member.

The process cartridge may include an elastic member to elastically support the waste toner collection route connecting member downwardly, so the conical shaped end of the waste toner collection route connecting member is adhered closely to the opening of the first slide opening and closing member and to the shutter of the first slide opening and closing member in the opened and closed positions of the waste toner collection route connecting member, respectively, and no aperture is formed therebetween.

A handle is installed proximal the protruded end of the toner cartridge of the rotary lever.

According to another embodiment of the present invention, a rotary opening and closing unit includes an empty toner supply route connecting member connected to the toner supply port of the toner cartridge and having a slit passing through in a vertical direction. A rotary opening and closing member has an opening that allows communication between the toner supply port and the toner inlet A circular arc shaped shutter shuts the toner supply port and the toner inlet and is connected to the other end of the rotary lever. The rotary opening and closing member rotates between a toner supply route's opened position having the opening located between the slit and the toner inlet and a toner supply route's closed position having the shutter located between the slit and the toner inlet.

The process cartridge includes a first elastic member adapted to elastically support the toner supply route connecting member downwardly for close adhesion between the toner supply route connecting member and the opening or the shutter of the rotary opening and closing member, and thereby forming no aperture therebetween. A second elastic member adapted to elastically support the waste toner collection route connecting member downwardly for close adhesion between the conical shaped end of the waste toner collection route connecting member and the opening of the first slide opening and closing member in an opened position, and between the conical shaped end of the waste toner collection route connecting member and the shutter of the first slide opening and closing member in a closed position, thereby forming no aperture therebetween.

A toner supply roller is rotatably installed inside the rotary opening and closing member to facilitate toner supply operation.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view of an image forming apparatus adopting a process cartridge according to one embodiment of the present invention;

FIG. 2 is a side view of a process cartridge according to one embodiment of the present invention;

FIG. 3 is a perspective view of a developer cartridge of a process cartridge according to one embodiment of the present invention;

FIG. 4 is a perspective view of a toner cartridge of a process cartridge according to one embodiment of the present invention;

FIG. 5 is a perspective view of a toner cartridge of FIG. 4 in an open state;

FIG. 6 is an exploded perspective view of a core portion of a toner cartridge illustrated in FIG. 4;

FIG. 7 is a perspective view of an opening and closing unit of a toner supply route and a waste toner collection route of a process cartridge according to one embodiment of the present invention, in which the toner supply route and the waste toner collection route are closed;

FIG. 8 is a cross sectional view of FIG. 7;

FIG. 9 is a perspective view of an opening and closing unit of a toner supply route and a waste toner collection route of a process cartridge according to one embodiment of the present invention, in which the toner supply route and the waste toner collection route are opened;

FIG. 10 is a cross sectional view of FIG. 9;

FIG. 11 is a perspective view of a first slide opening and closing member composing an opening and closing unit of a toner supply route and a waste toner collection route illustrated in FIG. 7 and FIG. 9;

FIG. 12 is a perspective view of an opening and closing unit of a toner supply route and a waste toner collection route of a process cartridge according to another embodiment of the present invention, in which the toner supply route and the waste toner collection route are closed;

FIG. 13 is a cross sectional view of FIG. 12;

FIG. 14 is a perspective view of an opening and closing unit of a toner supply route and a waste toner collection route of a process cartridge according to another embodiment of the present invention, in which the toner supply route and the waste toner collection route are opened; and

FIG. 15 is a cross sectional view of FIG. 14.

Throughout the drawings, like reference numerals will be understood to refer to like parts, components and structures.

### DETAILED DESCRIPTION OF THE EXEMPLARY EMBODIMENTS

An embodiment of the present invention will be described herein below with reference to the accompanying drawings.

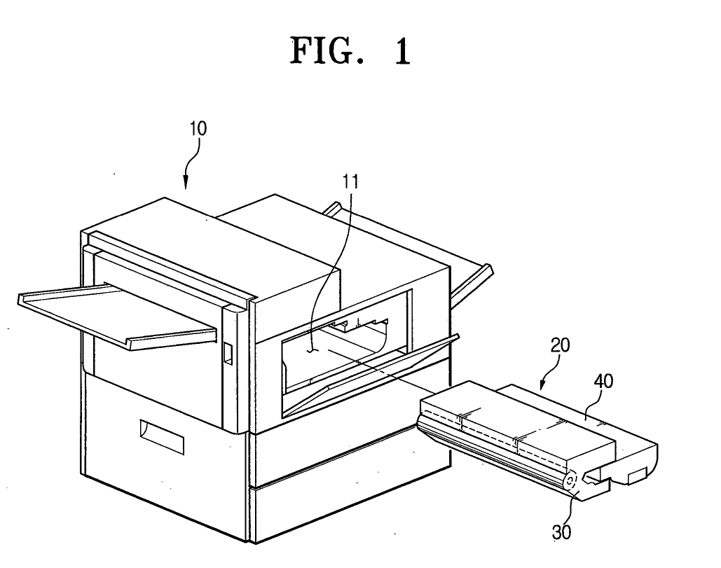

As shown in FIG. 1, a main body of an image forming apparatus includes a cartridge installing portion 11, in which a process cartridge 20 is selectively mounted.

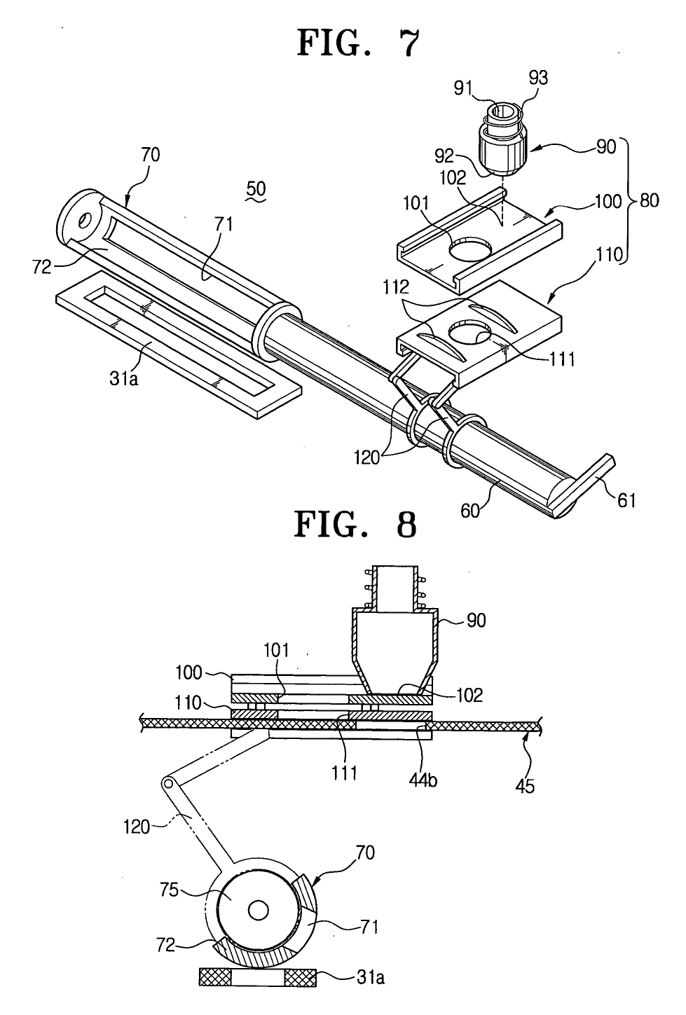

Referring to FIG. 1 and FIG. 7, the process cartridge 20 includes a developer cartridge 30, a toner cartridge 40, and an opening and closing unit 50 adapted to substantially simultaneously open and close a toner supply route and a waste collection route through a simple operation of a lever. The toner supply route is used to supply toner from the toner cartridge 40 to the developer cartridge 30, and the waste toner collection route is used to collect the waste toner from the developer cartridge 30 to the toner cartridge 40.

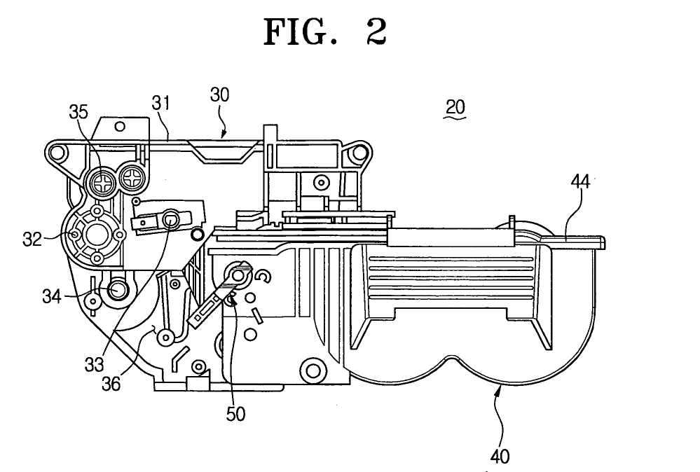

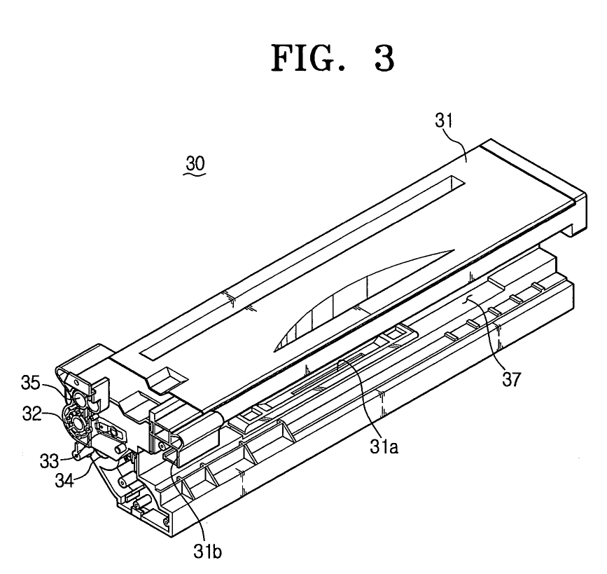

The developer cartridge 30, as shown in FIG. 2 and FIG. 3, includes a cartridge frame 31, a photosensitive medium 32 rotatably supported on the cartridge frame 31, a charging unit 33 adapted to charge the photosensitive medium 32, a magnetic developing roller 34 adapted to adhere toner supplied form the toner cartridge 40 to the photosensitive medium 32 and to develop an electrostatic latent image on the photosensitive medium 32. A cleaning unit 35 removes any residual waste toner that is not developed on the photosensitive medium 32.

The cartridge frame 31 includes a channel 37 having a toner inlet 31a and a waste toner outlet 31b at proper positions of the upper and lower parts, respectively, as shown in FIG. 3. Toner supplied from the toner cartridge 40 flows in through the toner inlet 31a. Waster toner removed by the cleaning unit 35 is discharged through the waste toner outlet 31b to the toner cartridge 40.

The developer cartridge 30 includes a carrier mixing-agitating element 36 adapted to mix and agitate the toner flowed inside through the toner inlet 31a with a carrier for use in conveying the toner. The magnetic toner-carrier mixture from the carrier mixing-agitating element 36 is then transferred to the magnetic developing roller 34. The developing roller 34 transfers substantially only toner to the photosensitive drum 32 with help of an electrostatic force, and the carrier left over on the developing roller is collected back to the carrier mixing-agitating element 36.

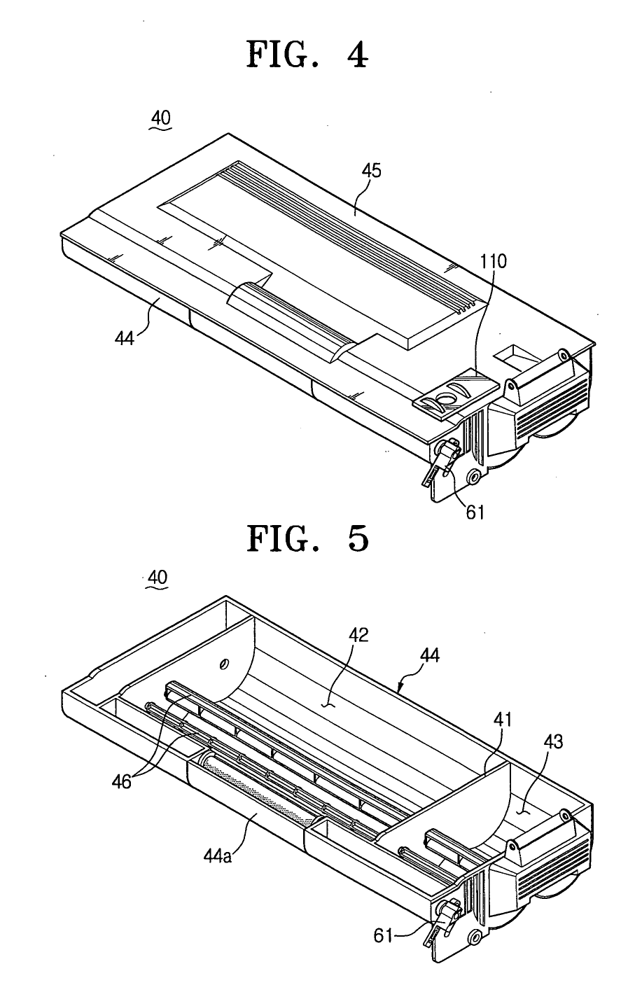

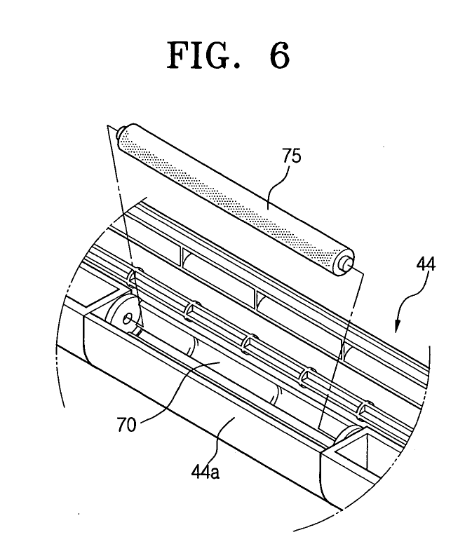

The toner cartridge, as shown in FIG. 4 through FIG. 6, includes a cartridge frame 44 whose interior is partitioned by a portioning wall 41 into a toner container 42 and a waste toner container 43, and a cover 45 for covering the frame 44.

One side of the toner container 42 of the frame 44 is a toner supply port 44a forming a toner supply route connected to a toner inlet 31a of the developer cartridge 30, thereby supplying toner to the developer cartridge 30. Also, one side of the cover 45 corresponding to the position of the waste toner container 43 of the frame 44 is a waste toner inlet 44b (refer to FIG. 8 and FIG. 10) forming a waste toner collection route connected to the waste toner outlet 31b, thereby dumping waste toner from the developer cartridge 30.

In addition, the toner cartridge 40 further includes an agitator 46 adapted to agitate the toner stored in the toner container 42 and to transfer the agitated toner towards the toner supply port 44a.

Now referring to FIGS. 2, 7, 8, and 11, the opening and closing unit 50 of the toner supply route and the waste toner collection route includes a rotary lever 60, a rotary opening and closing unit 70, and a slide opening and closing unit 80.

The rotary lever 60 is rotatably installed on the toner cartridge 40 in such a manner that one end thereof is outwardly protruded. Therefore, a user is able to rotate the lever 60 by holding the protruded end and rotating it by a predetermined angle in the forward or backward direction. To facilitate the user's operation, a handle 61 is installed on the protruded end.

The rotary opening and closing unit 70 is connected to the other end of the rotary lever 60, and includes a rotary opening and closing unit 70 (the same reference numeral is used because this is the same member with the above-described rotary opening and closing unit) that is rotatably installed on the toner supply port 44a.

The rotary opening and closing member 70 includes an opening 71 through which the toner supply port 44a of the toner cartridge 40 and the toner inlet 31a of the developer cartridge 30 are communicated with each other, and a circular arc shaped shutter 72 adapted to shut the toner supply port 44a and the toner inlet 31a. The rotary opening and closing member 70 rotates to a toner supply route's opened position (refer to FIG. 10) where the opening 71 is aligned with the toner inlet 31a, and to a toner supply route's closed position (refer to FIG. 8) where the shutter 72 is aligned with the toner inlet 31a.

The opening and closing of the toner supply route with the aid of the rotary opening and closing member 70 may be accomplished without much difficulty by rotating the rotary lever 60 in the forward or backward direction. Meanwhile, a toner supply roller 75 is rotatably mounted inside the rotary opening and closing member 70. Hence, when the toner supply roller 75 starts rotating by a separate driving source, the toner in the toner container 42 is well supplied to the developer cartridge 30.

The slide opening and closing unit 80 includes a waste toner collection route connecting member 90, a first slide opening and closing member 100, and a second slide opening and closing member 110.

The waste toner collection route connecting member 90 is connected to the waste toner outlet 31b of the developer cartridge, and has a through hole 91 in a vertical direction and a substantially conically-shaped end 92. Preferably, the waste toner collection route connecting member 90 is movable in the vertical direction, and is elastically biased downwardly with the aid of an elastic member 93, such as, a compression coil spring.

The first slide opening and closing member 100 is installed slidably on the side of the waste toner outlet 31b of the developer cartridge 30, and is in a rectangular plate shape having an opening 101 for communicating the through hole 91 of the waste toner collection connecting member 90 with the waste toner inlet 44b of the toner cartridge 40 and having a shutter 102 adapted to shut the through hole 91 and the waste toner inlet 44b. The first slide opening and closing member 100 is also slidable between the waste toner collection route's opened position (refer to FIG. 10) where the through hole 91 is aligned with the opening 101, and the waste toner collection route's closed position (refer to FIG. 8) where the through hole 91 is aligned with the shutter 102.

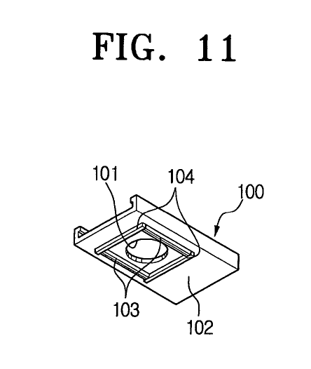

The first slide opening and closing member 100 includes a pair of guide members 103 and a pair of hooking members 104, as shown in FIG. 11, adapted to couple the first slide opening and closing member 100 to the second slide opening and closing member 110. The two slide opening and closing members 100 and 110 are coupled with each other for the combination of the toner cartridge 40 and the developer cartridge 30. The guide members 103 and the hooking members 104 are formed on opposite sides, respectively, encompassing the opening 101. Preferably, the guide members 103 are rounded.

The second slide opening and closing member 110 is installed slidably on the side of the waste toner inlet 44b of the toner cartridge's cover 45, as shown in FIG. 4, and is connected to the rotary lever 60 by a link 120 (FIG. 8). Therefore, when the user rotates the rotary lever 60 in the forward and backward direction, the second slide opening and closing member 110 also slides.

The second slide opening and closing member 110 combines with the first slide opening and closing member 100 when the toner cartridge 40 is attached to the developer cartridge 30, and facilitates movement of the first slide opening and closing member 100 between opened and closed positions described above. The second slide opening and closing member 110 has a connection hole 111 aligned with the opening 101, and a pair of jaws 112 in a one-to-one correspondence with the hooking members 104. The jaws 112 are preferably rounded to facilitate engaging the guide members 103.

The waste toner collection route is opened when the conical shaped end 92 of the waste toner collection route connecting member 90 in its opened position is fitted into the opening 101 of the first slide opening and closing member 100, as shown in FIG. 10. The waste toner collection route is closed when the conical shaped end 92 reaches the shutter 102 of the first slide opening and closing member 100, as shown in FIG. 8. Since the waste toner collection route connecting member 90 is elastically biased downwardly by the elastic member 93, the conical shaped end 92 may be attached tightly to the opening 101 or the shutter 102 creating substantially no aperture or crack therebetween. Therefore, the waste toner is substantially prevented from leakage despite the number of times the toner cartridge 40 may be attached and detached to and from the developer cartridge 30.

The following will now explain, with reference to FIG. 7 through FIG. 10, the operation of the opening and closing unit 50 for the toner supply route and the waste toner collection route of the process cartridge according to one embodiment of the present invention.

FIG. 7 and FIG. 8 respectively illustrate perspective and cross-sectional views of the toner supply route and the waste toner collection route being closed. The user may easily yet precisely close the toner supply route and the waste toner collection route simply by rotating the rotary lever 60 counterclockwise by a predetermined angle.

As shown in the drawings, the rotary opening and closing unit 70 is rotated to the toner supply route's closed position where the shutter 72 of the rotary opening and closing unit 70 is aligned with the toner inlet 31a. On the other hand, when the first and second slide opening and closing members 100 and 110 of the slide opening and closing unit 80 slide to the left side on the drawing, the slide opening and closing unit 80 shifts to the waste toner collection route's closed position where the waste toner collection route connecting member 90 meets or contacts with the shutter 102 of the first slide opening and closing member 100. In this manner, even if the toner cartridge 40 is separated from the developer cartridge 30, the toner or the waste toner does not leak.

If the user rotates the rotary lever 60 clockwise by a predetermined angle when the toner supply route and the waste toner collection route are in a closed state, the rotary opening and closing unit 70 rotates clockwise, and the slide opening and closing unit 80 shifts to the right side on the drawing. This results in opening of the toner supply route and the waste toner collection route.

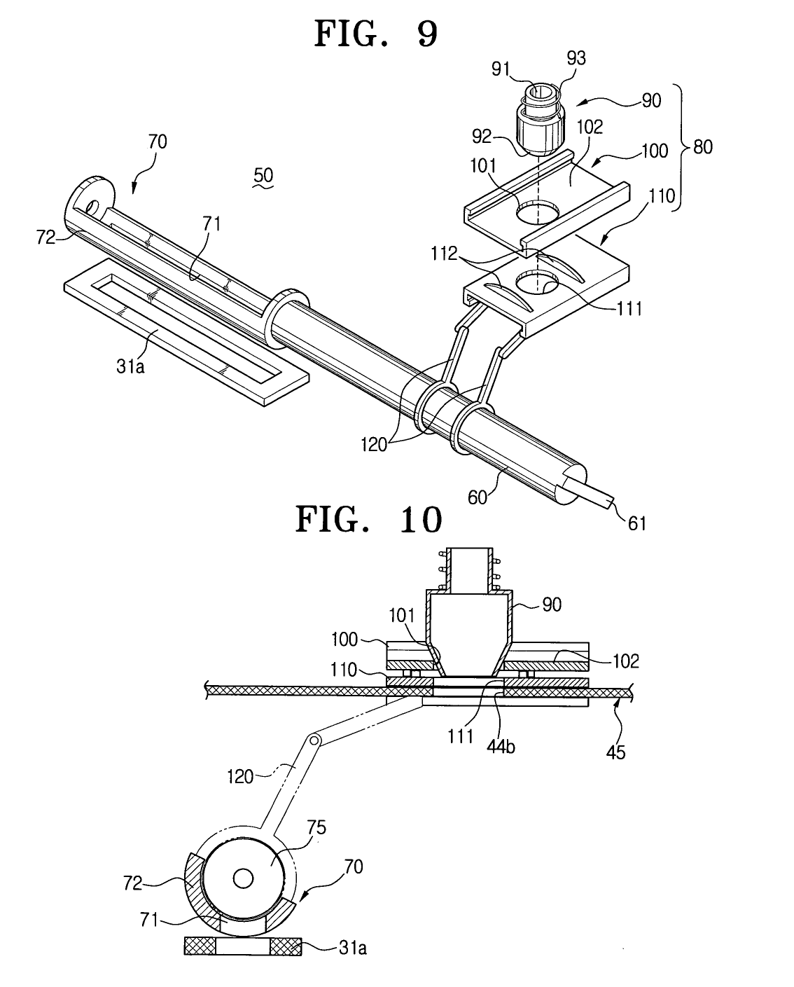

Referring to FIG. 9 and FIG. 10, when the toner supply route and the waste toner collection route are opened, the opening 71 of the rotary opening and closing unit 70 is aligned with the toner inlet 31a, and the waste toner collection route connecting member 90 of the slide opening and closing unit 80 is fitted into the opening 101 of the first slide opening and closing member 100. Thus, the user may easily and precisely open the toner supply route and the waste toner collection route simply by rotating the rotary lever 60 clockwise by the predetermined angle.

If the user wants to close the opened toner supply route and waste toner collection route, he/she simply needs to rotate the rotary lever 60 counterclockwise by the predetermined angle. Then, the toner supply route and the waste toner collection route are closed again as shown in FIG. 7 and FIG. 8. In short, the process cartridge according to one embodiment of the present invention helps the user to easily and precisely open and close the toner supply route and the waste toner collection route.

FIG. 12 through FIG. 15 illustrate the structure and operation of the opening and closing unit for the toner supply route and the waste toner collection route according to another embodiment of the present invention.

As depicted in FIGS. 12 through 15, the opening and closing unit 50 for the toner supply route and the waste toner collection route of the process cartridge according to another embodiment of the present invention has substantially the same structure as the previously described embodiment except for a rotary opening and closing unit 700. Accordingly, the same reference numerals will be used for the same elements in this embodiment, and the operational description thereof will not be provided here.

The rotary opening and closing unit 700 of the process cartridge according to another embodiment of the invention includes a rotary opening and closing member 70 (this is already described in the previous embodiment) and a toner supply route connecting member 710.

The toner supply route connecting member 710 is installed in the toner supply port 44a of the toner cartridge 40 (FIG. 5), and has a slit 711 passing through in the vertical direction and a semicircular shaped end 712. A boss 713 is formed on both sides of the upper portion of the semicircular shaped end 712, and an elastic member 720 is installed on each boss 713 to elastically support the toner supply route connecting member 710 downwardly. Preferably, the toner supply route connecting member 710 is installed to be vertically movable.

The rotary opening and closing unit 70 has an opening 71 for allowing communication between a slit 711 of the toner supply route connecting member 710 and a toner inlet 31a of the developer cartridge, and a circular arc shaped shutter 72 for shutting the slit 711 and the toner inlet 31a. The rotary opening and closing unit 70 is connected to the other end of the rotary lever 60, and rotates with the rotary lever 60. More specifically, the rotary opening and closing member 700 rotates between a toner supply route's opened position having the opening 71 located between the slit 711 and the toner inlet 31a and a toner supply route's closed position having the shutter 72 located between the slit 711 and the toner inlet 31a.

In this manner, the toner supply port 44a of the toner cartridge 40 and the toner inlet 31a of the developer cartridge 30 are in communication with each other or shut (or blocked) to open or close the toner supply route as desired. Since the lower portion of the toner supply route connecting member 710 is elastically biased by an elastic member 720, no aperture or slit is formed when the semicircular shaped end 712 of the toner supply route connecting member 710 is in contact with the opening 71 or the shutter 72. As the toner supply route is opened or closed in a precise manner, the toner contained inside is substantially prevented from leaking.

Particularly in the present embodiment, a toner supply roller 75 is installed inside the toner supply route connecting member 710 to facilitate the toner supply operation.

The process cartridge is capable of substantially simultaneously opening and closing the toner supply route and the waste toner collection route as described in the previous embodiment.

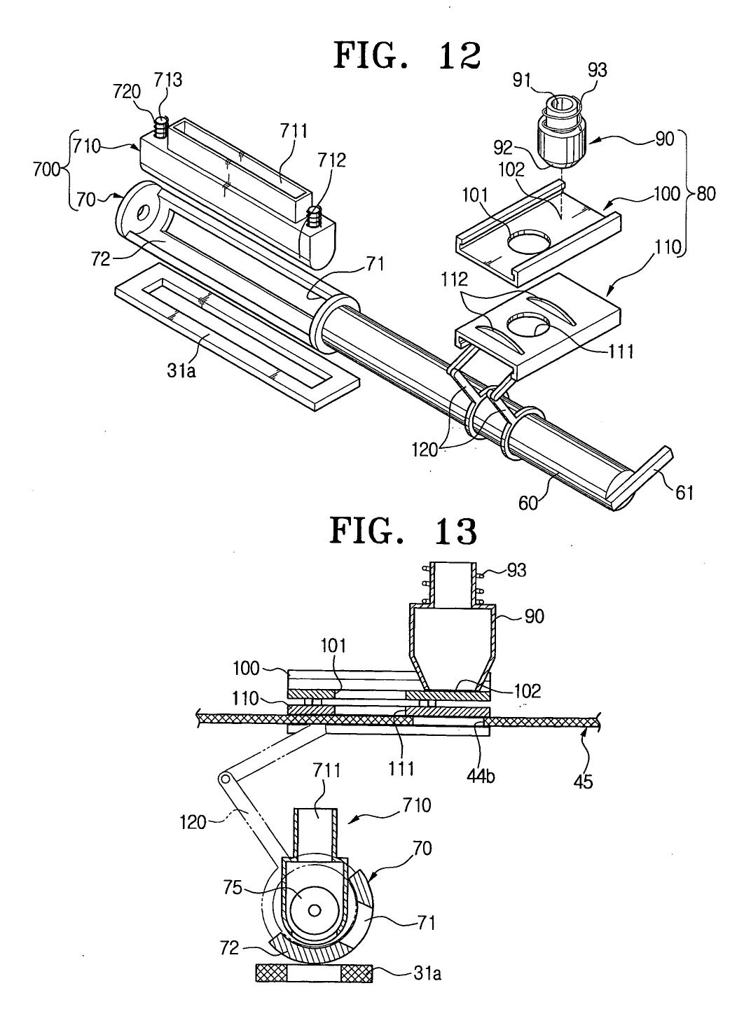

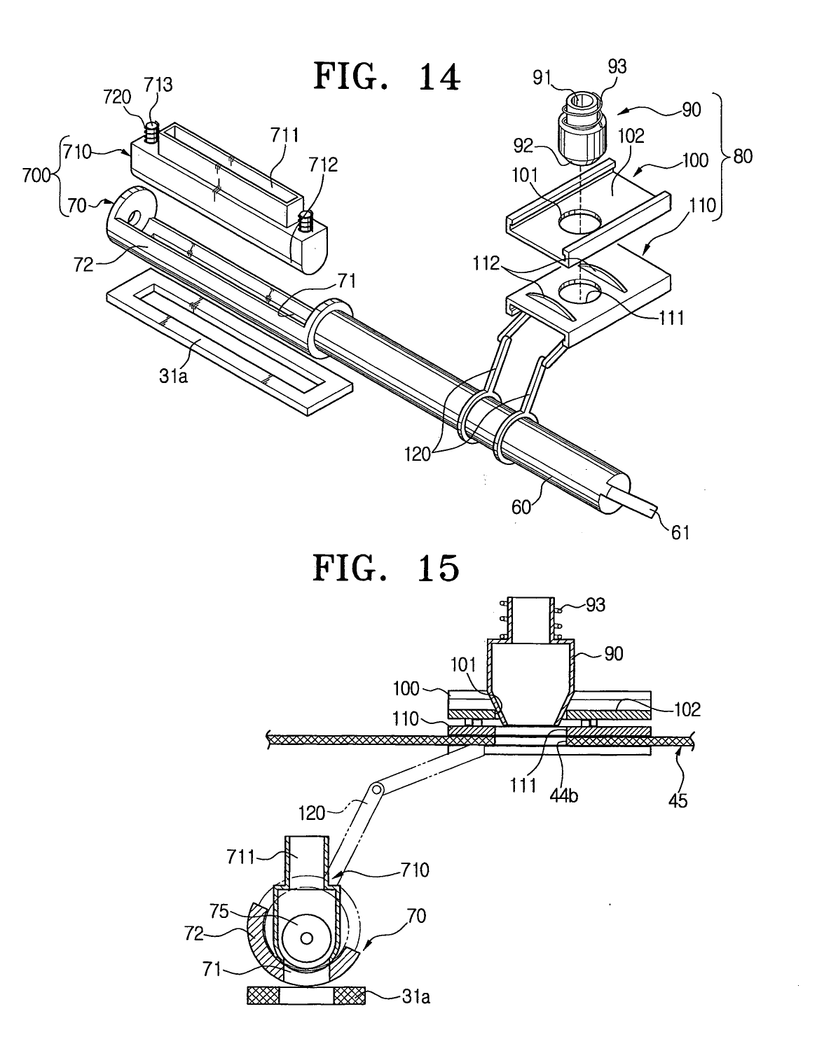

That is, when the user rotates the rotary lever 60 clockwise by a predetermined angle while keeping the toner supply route and the waste toner collection route are closed as shown in FIGS. 12 and 13, the rotary opening and closing unit 700 and the slide opening and closing unit 80 move and are opened as shown in FIGS. 14 and 15.

Whether the toner supply route and the waste toner collection route are opened or closed, the toner supply route connecting member 710 and the waste toner collection route connecting member 90 are elastically biased downwardly by the elastic members 720 and 93. Therefore, substantially no aperture or slit is formed at a contact area since two members are adhered closely to each other. In effect, toner or waste toner is substantially prevented from leaking at any time during the printing operation and during the separation of the toner cartridge from the developer cartridge.

In conclusion, the present invention allows the user to open or close the toner supply route and the waste toner collection route at the same time through a simple operation of the rotary lever, thereby making it very easy to use and handle the process cartridge.

The process cartridge according to an embodiment of the present invention has a very simple structure for the toner supply route and the waste toner collection route. This consequently reduces a large amount of the associated manufacturing costs.

Moreover, the opening and closing unit for the toner supply route and the waste toner collection route of the process cartridge has a high reliability of operation, so the toner or the waste toner is substantially prevented from leaking at any time during operation or separation for repair. Therefore, the image forming apparatus is protected from the contamination caused by the toner and/or waste toner leakage.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art.

1. A process cartridge for an image forming apparatus, comprising:
a developer cartridge having a toner inlet and a waste toner outlet;
a toner cartridge detachably mountable on the developer cartridge, and having a toner supply port and a waste toner inlet, the toner supply port and the toner inlet forming a toner supply route to the developer cartridge, and the waste toner outlet and the waste toner inlet forming a waste toner collection route from the developer cartridge; and
an opening and closing unit for substantially simultaneously opening and closing the toner supply route and the waste toner collection route through a lever operation.

2. The process cartridge according to claim 1, wherein
the developer cartridge has a photosensitive medium and a frame adapted to rotatably support the photosensitive medium, the frame having a channel formed at proper positions of the upper and lower portions of the toner inlet and the waste toner outlet, respectively, and the toner cartridge being in communication with the developer cartridge through the channel.

3. The process cartridge according to claim 2, wherein
the toner cartridge has a frame having an interior partitioned into a toner container and a waste toner container, and a cover combined with the frame, the toner supply port being formed on one side of the toner container of the frame and the waste toner inlet being formed on another side of the cover corresponding to the waste toner container of the frame.

4. The process cartridge according to claim 3, wherein
the opening and closing unit for the toner supply route and the waste toner collection route includes:
a rotary lever installed on the toner cartridge having one end protruding outwardly thereof and adapted to rotate in the forward and backward direction;
a rotary opening and closing unit rotating with the rotary lever to open and close the toner supply route; and
a slide opening and closing unit moving with the rotation of the rotary lever adapted to open and close the waste toner collection route.

5. The process cartridge according to claim 4, wherein
the rotary opening and closing unit includes:
an opening adapted to facilitate communication between the toner supply port and the toner inlet;
a circular arc shaped shutter to shut the toner supply port and the toner inlet; and
a rotary opening and closing member connected to the other end of the rotary lever, and rotating to a toner supply route's opened position where the opening is aligned with the toner inlet and to a toner supply route's closed position where the shutter is aligned with the toner inlet.

6. The process cartridge according to claim 4, wherein
the slide opening and closing unit includes:
a waste toner collection route connecting member connected to the waste toner outlet of the developer cartridge, and having a through hole in a vertical direction and a conical shaped end;
a first slide opening and closing member having an opening to facilitate communication between the through hole of the waste toner collection route connecting member and the waste toner inlet, and a shutter to shut the through hole and the waste toner inlet, and sliding between a waste toner collection route's opened position where the through hole is aligned with the opening at a lower portion of the waste toner outlet and a waste toner collection route's closed position where the through hole is aligned with the shutter; and
a second slide opening and closing member movably installed on one side of the waste toner inlet of the toner cartridge, being connected to the rotary lever by a link member to slide in response to rotation of the rotary lever, and being combined with the first slide opening and closing member at a time of the combination of the toner cartridge with the developer cartridge to move the first slide opening and closing member to the opened and closed positions.

7. The process cartridge according to claim 4, wherein
the rotary opening and closing unit includes:
an opening to facilitate communication between the toner supply port and the toner inlet;
a circular arc shaped shutter to shut the toner supply port and the toner inlet; and
a rotary opening and closing member connected to the other end of the rotary lever, and rotating to a toner supply route's opened position where the opening is aligned with the toner inlet and to a toner supply route's closed position where the shutter is aligned with the toner inlet, and
the slide opening and closing unit includes:
a waste toner collection route connecting member connected to the waste toner outlet of the developer cartridge and having a through hole in a vertical direction and a conical shaped end;
a first slide opening and closing member having an opening to facilitate communication between the through hole of the waste toner collection route connecting member and the waste toner inlet, and a shutter to shut the through hole and the waste toner inlet, and sliding between a waste toner collection route's opened position where the through hole is aligned with the opening at a lower portion of the waste toner outlet and a waste toner collection route's closed position where the through hole is aligned with the shutter; and
a second slide opening and closing member movably installed on one side of the waste toner inlet of the toner cartridge, being connected to the rotary lever by a link member adapted to slide in response to rotation of the rotary lever, and being combined with the first slide opening and closing member at a time of the combination of the toner cartridge with the developer cartridge adapted to move the first slide opening and closing member to the opened and closed positions.

8. The process cartridge according to claim 7, wherein
a toner supply roller is rotatably installed inside the rotary opening and closing member to facilitate a toner supply operation.

9. The process cartridge according to claim 7, wherein
a pair of guide members and a pair of hooking members are installed on a lower surface of the first slide opening and closing member adapted to engage the second slide opening and closing member, a pair of jaws in a one-to-one correspondence to the hooking members are installed on an upper surface of the second slide opening and closing member, and a connecting hole is formed between the jaws of the second slide opening and closing member to be in a correspondence to the opening of the first slide opening and closing member.

10. The process cartridge according to claim 7, wherein
a conical shaped end of the waste toner collection route connecting member in an opened position is fitted into the opening of the first slide opening and closing member, and a conical shaped end in a closed position is in contact with the shutter of the first slide opening and closing member.

11. The process cartridge according to claim 10, wherein
an elastic member elastically supports the waste toner collection route connecting member downwardly closely adhere the conical shaped end of the waste toner collection route connecting member to the opening of the first slide opening and closing member and to the shutter of the first slide opening and closing member in the opened and closed positions of the waste toner collection route connecting member, respectively, and substantially no aperture is formed therebetween.

12. The process cartridge according to claim 7, wherein
a handle is installed proximal the protruded end of the toner cartridge of the rotary lever.

13. The process cartridge according to claim 4, wherein
the rotary opening and closing unit includes:
an empty toner supply route connecting member connected to the toner supply port of the toner cartridge, and having a slit passing through in a vertical direction;
a rotary opening and closing member having an opening to facilitate communication between the toner supply port and the toner inlet, and a circular arc shaped shutter adapted to shut the toner supply port and the toner inlet, and being connected to the other end of the rotary lever, and
the rotary opening and closing member rotates between a toner supply route's opened position having the opening located between the slit and the toner inlet and a toner supply route's closed position having the shutter located between the slit and the toner inlet.

14. The process cartridge according to claim 13, wherein
the slide opening and closing unit includes:
a waste toner collection route connecting member connected to the waste toner outlet of the developer cartridge, and having a through hole in a vertical direction and a substantially conically-shaped end;
a first slide opening and closing member having an opening to facilitate communication between the through hole of the waste toner collection route connecting member and the waste toner inlet, and a shutter adapted to shut the through hole and the waste toner inlet, and sliding between a waste toner collection route's opened position where the through hole is aligned with the opening at a lower portion of the waste toner outlet and a waste toner collection route's closed position where the through hole is aligned with the shutter; and
a second slide opening and closing member is movably installed on one side of the waste toner inlet of the toner cartridge, being connected to the rotary lever by a link member and adapted to slidein response to rotation of the rotary lever, and being engaged with the first slide opening and closing member at a time of the combination of the toner cartridge with the developer cartridge to move the first slide opening and closing member to the opened and closed positions.

15. The process cartridge according to claim 14, further comprising
an elastic member adapted to elastically support the toner supply route connecting member downwardly for close adhesion between the toner supply route connecting member and the opening or the shutter of the rotary opening and closing member, and thereby forming substantially no aperture therebetween.

16. The process cartridge according to claim 14, further comprising:
a first elastic member adapted to elastically support the toner supply route connecting member downwardly for close adhesion between the toner supply route connecting member and the opening or the shutter of the rotary opening and closing member, and thereby forming substantially no aperture therebetween; and
a second elastic member adapted to elastically support the waste toner collection route connecting member downwardly for close adhesion between the conical shaped end of the waste toner collection route connecting member and the opening of the first slide opening and closing member in an opened position, and between the substantially conically-shaped end of the waste toner collection route connecting member and the shutter of the first slide opening and closing member in a closed position, thereby forming substantially no aperture therebetween.

17. The process cartridge according to claim 16, wherein
a toner supply roller is rotatably installed inside the rotary opening and closing member to facilitate toner supply operation.

18. The process cartridge according to claim 16, wherein
a pair of guide members and a pair of hooking members are installed on a lower surface of the first slide opening and closing member to engage the second slide opening and closing member;
a pair of jaws in a one-to-one correspondence to the hooking members are installed on an upper surface of the second slide opening and closing member; and
a connecting hole is formed between the jaws of the second slide opening and closing member and adapted to be aligned with the opening of the first slide opening and closing member.

19. The process cartridge according to claim 16, wherein
a handle is installed proximal the protruded end of the toner cartridge of the rotary lever.

20. The process cartridge according to claim 3, wherein
the developer cartridge includes:
a charging unit adapted to charge the photosensitive medium;
a carrier mixing-agitating element adapted to mix and agitate toner supplied from the toner cartridge and a carrier to convey the toner;
a magnetic developing roller adapted to transfer the magnetic toner-carrier mixture from the carrier mixing-agitating element onto the photosensitive medium, and
a cleaning unit to remove any residual waste toner on the photosensitive medium.

21. The process cartridge according to claim 20, wherein
the toner cartridge comprises an agitator adapted to agitate the toner stored in the toner container and to transfer the toner toward the toner supply port.
